(19) United States
(12) Patent Application Publication
(10) Pub. No.: US 2005/0265219 A1
(43) Pub. Date: Dec. 1, 2005

(54) Orthogonal frequency division multiplex (OFDM) packet detect unit, method of detecting an OFDM packet and OFDM receiver employing the same

(75) Inventors: Timothy F. Murphy, Ramona, CA (US); Ralph E. Temple, San Diego, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/843,056

(22) Filed: May 11, 2004

(51) Int. Cl. H04J 11/00

(52) U.S. Cl. 370/208

(57) ABSTRACT

The present invention provides an orthogonal frequency division multiplex (OFDM) packet detect unit. In one embodiment, the OFDM packet detect unit includes a correlation indicator configured to cross-correlate a received symbol and a stored standard symbol to yield a correlation result. Additionally, the OFDM packet detect unit also includes a threshold discriminator coupled to the correlation indicator and configured to produce a packet detect signal for a fast Fourier transform (FFT) placement peak based on a comparison between the correlation result and a threshold.

### TECHNICAL FIELD OF THE INVENTION

The present invention is directed, in general, to a communication system and, more specifically, to an orthogonal frequency division multiplex (OFDM) packet detect unit, a method of detecting an OFDM packet and an OFDM receiver employing the packet detect unit or the method.

### BACKGROUND OF THE INVENTION

Communication systems extensively employ digital signal processing techniques to accomplish increasingly more sophisticated and complex computational algorithms. Expanding applications are being fueled by new technologies and increasing demand for products and services. In wireless mobile communications, the channel is often time-varying due to relative motion between the transmitter and the receiver and also due to multipath propagation. Such a variation in time is called fading and can impair system performance severely. When the data rate is high compared to the channel bandwidth, multipath propagation becomes frequency dependent and may cause intersymbol interference (ISI).

Orthogonal Frequency Division Multiplexing (OFDM) converts an ISI channel into a set of parallel subchannels that are free of ISI. An OFDM training sequence is inserted at the beginning of each transmitted frame in front of the data payload and removed from each received frame. The OFDM training sequence may conform to the IEEE 802.11a/g specifications, which allows an OFDM receiver to accomplish synchronization and channel estimation. This training sequence typically includes ten short sequence fields followed by two long sequence fields and then a signal field. The two long sequence fields and signal field employ guard intervals that allow ISI elimination. An inverse fast Fourier transform (IFFT) is employed at the OFDM transmitter and a fast Fourier transform (FFT) is employed at the OFDM receiver. A cross correlator and peak detector at the OFDM receiver is typically employed to indicate a correct location of the FFT placement, which affects synchronization.

An OFDM packet-detect, physical layer algorithm employs auto-correlation to detect the OFDM short training symbols using both received and repeated short training symbols. An OFDM short-to-long training symbol boundary is detected when the value of the auto-correlation degrades sufficiently. However, this OFDM packet-detect algorithm can erroneously trigger on noise or non-IEEE 802.11a/g events, detrimentally affecting the FFT placement. If the packet-detect algorithm triggers erroneously, the OFDM receiver performs an FFT symbol boundary estimate and decodes the OFDM signal field, even though it is erroneous.

The OFDM signal field is protected with only a single parity bit, and its four bit rate field typically has only 50% of the possible rates defined. If an invalid packet detection occurs, a 25% probability exists that the OFDM receiver will fail to find an error in the OFDM signal field, waste its computing resources processing the invalid packet and pass the decoded packet to a Media Access Controller (MAC), which then must waste its resources determining that the packet is invalid. Not only does the receiver waste its resources processing invalid packets, the processing may cause the receiver to miss a valid OFDM packet and further cause the MAC to report a frame check sequence error associated with the invalid packet when such error did not in fact occur.

Accordingly, what is needed in the art is a more reliable way to detect the presence of valid OFDM packets and thereby reduce the detection and processing of invalid packets.

### SUMMARY OF THE INVENTION

To address the above-discussed deficiencies of the prior art, the present invention provides an OFDM packet detect unit. In one embodiment, the OFDM packet detect unit includes a correlation indicator configured to cross-correlate a received symbol and a stored standard symbol to yield a correlation result. Additionally, the OFDM packet detect unit also includes a threshold discriminator coupled to the correlation indicator and configured to produce a packet detect signal for an FFT placement peak based on a comparison between the correlation result and a threshold.

In another aspect, the present invention provides a method of detecting an OFDM packet. The method includes cross-correlating a received symbol and a stored standard symbol to yield a correlation result and producing a packet detect signal for an FFT placement peak based on a comparison between the correlation result and a threshold.

The present invention provides, in yet another aspect, an OFDM receiver. The OFDM receiver employs a receive section that is coupled to a receive antenna, an FFT section that is coupled to the receive section and an OFDM packet detect unit coupled to the FFT section. The OFDM packet detect unit includes a correlation indicator that dross-correlates a received symbol and a stored standard symbol to yield a correlation result. The OFDM packet detect unit also includes a threshold discriminator, coupled to the correlation indicator, that produces a packet detect signal for an FFT placement peak based on a comparison between the correlation result and a threshold. The OFDM receiver also employs an output section that is coupled to the OFDM packet detect unit.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an orthogonal frequency division multiplex (OFDM) transmitter/receiver pair constructed in accordance with the principles of the present invention;

FIG. 2 illustrates a diagram of an embodiment of an OFDM packet detect unit constructed in accordance with the principles of the present invention; and

FIG. 3 illustrates a flow diagram of an embodiment of a method of detecting an OFDM packet carried out in accordance with the principles of the present invention.

### DETAILED DESCRIPTION

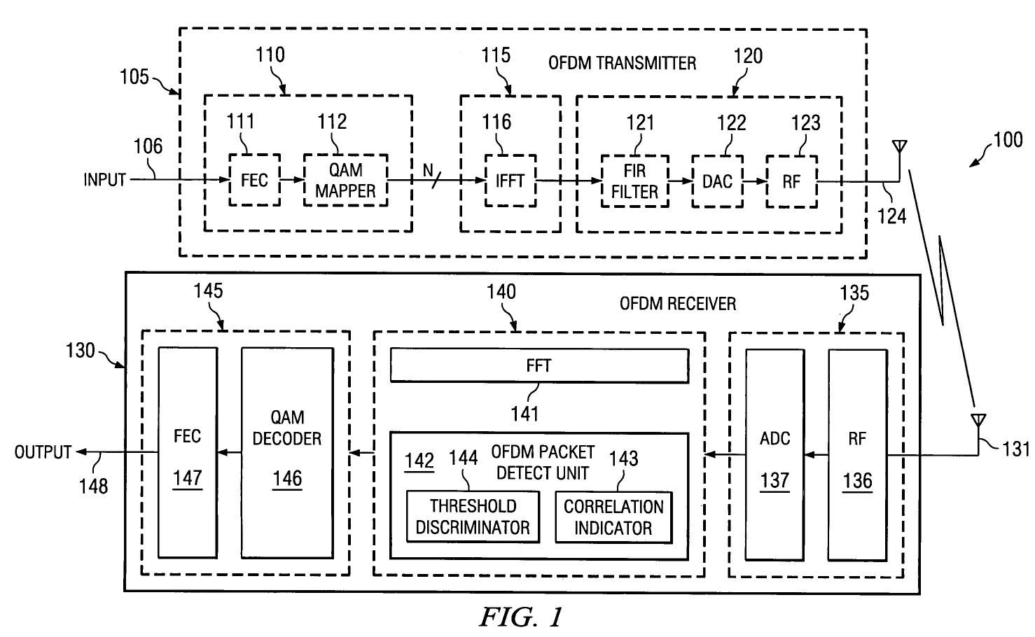

Referring initially to FIG. 1, illustrated is a system diagram of an embodiment of an OFDM transmitter/receiver pair, generally designated 100, constructed in accordance with the principles of the present invention. The OFDM transmitter/receiver pair 100 includes an OFDM transmitter 105 and an OFDM receiver 130. The OFDM transmitter 105 includes a transmitter input 106, a transmitter input section 110, a transmitter transform section 115, a transmitter output section 120 and a transmit antenna 124. The OFDM receiver 130 includes a receive antenna 131, a receiver input section 135, an FFT section 140, a receiver output section 145 and a receiver output 148.

The transmitter input section 110 includes a transmit forward error correction (FEC) stage 111, coupled to the transmitter input 106, and a quadrature amplitude modulation (QAM) mapper stage 112. The transmitter transform section 115 includes an N-point, inverse fast Fourier transform (IFFT) stage 116. The transmitter output section 120 includes a finite impulse response (FIR) filter stage 121, a digital-to-analog converter (DAC) stage 122 and a transmit radio frequency (RF) stage 123, which is coupled to the transmit antenna 124.

The receiver input section 135 includes a receive RF stage 136, which is coupled to the receive antenna 131, and an analog-to-digital converter (ADC) stage 137. The FFT section 140 includes an FFT stage 141 and an OFDM packet detect unit 142. The receiver output section 145 includes a QAM decoder stage 146 and a receive FEC stage 147, which is coupled to the receiver output 148.

The transmit FEC stage 111 provides forward error correction for a transmit input signal obtained from the transmitter input 106 and supplies an error-corrected input signal to the QAM mapper stage 112. The QAM mapper stage 112 codes the error-corrected transmit input signal for transmission and provides it to the IFFT stage 116. The N-point IFFT stage 116 transforms the error-corrected transmit input signal from the frequency domain to the time domain and supplies it to the FIR filter stage 121, where it is further filtered for transmission. The DAC stage 122 converts the transformed, filtered and error-corrected transmit input signal from a digital transmit signal to an analog transmit signal wherein it is further conditioned and modulated for transmission by the transmit RF stage 123 employing the transmit antenna 124.

The transmitted signal is received by the receive RF stage 136 employing the receive antenna 131. This analog, time-domain receive signal is conditioned, demodulated and supplied to the ADC stage 137 wherein it is converted from an analog signal to a digital signal and supplied to the FFT section 140. The FFT stage 141 transforms the received signal from the time domain to the frequency domain and employs the OFDM packet detect unit 142 to indicate an appropriate timing for the conversion. The QAM decoder 146 decodes the transformed receive signal wherein it is forward error corrected by the FEC stage 147 and provided as a receive output signal from the receiver output 148.

The OFDM packet detect unit 142 includes a correlation indicator 143 and a threshold discriminator 144. The correlation indicator 143 cross-correlates a received symbol and a stored standard symbol to yield a correlation result. The threshold discriminator 144 is coupled to the correlation indicator 143 and produces a packet detect signal for an FFT placement peak based on a comparison between the correlation result and a threshold. The magnitude of the correlation result depends on the similarity of the received symbol and the stored standard symbol. In the illustrated embodiment, the stored standard symbol is a long training sequence conforming to a standard selected from the group consisting of IEEE 802.11a or IEEE 802.11g. The correlation result reaches a correlation peak when the received symbol is also an appropriately related long training sequence.

The comparison between the correlation result and the threshold allows an additional degree of verification that the received symbol is indeed a portion of an OFDM packet rather than a response to noise or another non-OFDM signal. The level of verification required may be determined by the threshold level that is selected. The threshold level is programmable and may be implemented by employing one or more of the group consisting of software, firmware or hardware. This action allows the packet detect signal to provide an enhanced indication of a correct FFT placement location involving a valid OFDM packet, thereby allowing a more reliable operation of the OFDM receiver 130.

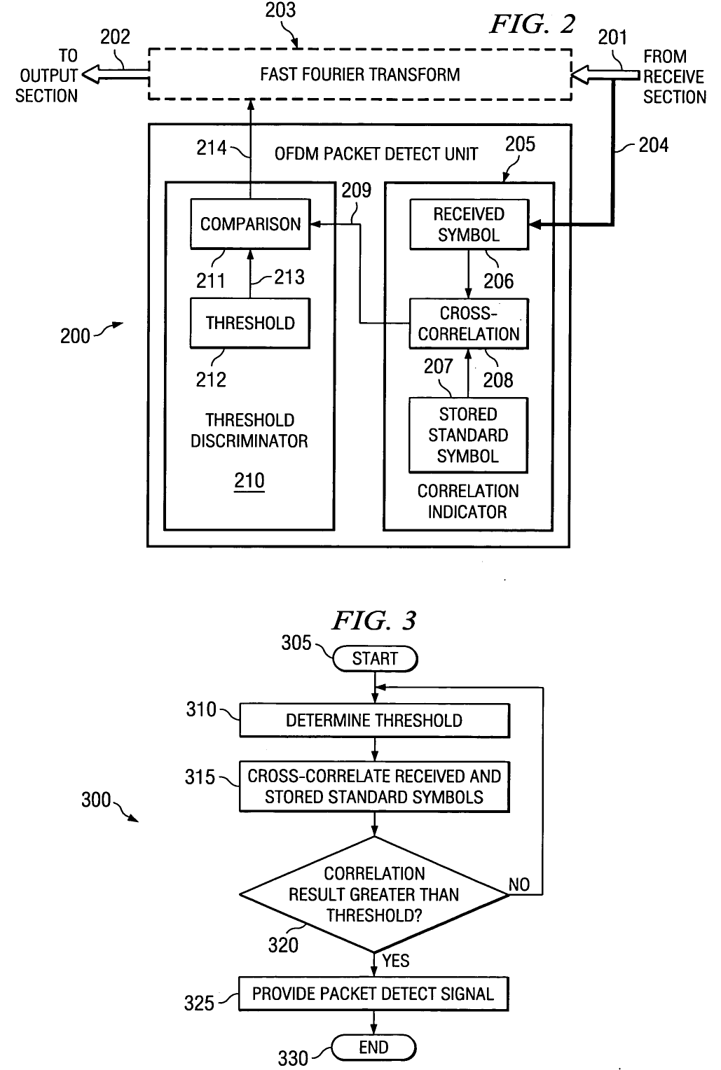

Turning now to FIG. 2, illustrated is a diagram of an embodiment of an OFDM packet detect unit, generally designated 200, constructed in accordance with the principles of the present invention. The OFDM packet detect unit 200 is associated with an FFT stage 203 that receives a digital, time-domain input signal 201 and provides an equivalent frequency-domain output signal 202. The OFDM packet detect unit 200 includes a correlation indicator 205 and a threshold discriminator 210.

The correlation indicator 205 receives an input signal 204 that is at least a portion of the time-domain input signal 201 and includes a received symbol module 206, a stored standard symbol module 207 and a cross-correlation module 208 that yields a correlation result 209. The threshold discriminator 210 includes a comparison module 211 and a threshold module 212 that provides a threshold 213. The comparison module 211 receives the correlation result 209 and produces a packet detect signal 214. The packet detect signal 214 allows a correct placement for the FFT operation in the time-domain input signal 201.

The received symbol module 206 may provide buffering for a received symbol being cross-correlated with a stored long training sequence provided by the stored standard symbol module 207. Cross-correlation involves convolving the received symbol with the stored long training sequence. When the received symbol is a corresponding long training sequence associated with an OFDM packet demonstrating high signal-to-noise, the correlation result builds to a sustained peak value and then diminishes during correlation. However, high noise or strong, interfering non-OFDM signal environments may provide a correlation result that significantly departs from this ideal and may otherwise cause an invalid packet to be processed or a valid packet to be missed.

The comparison module 211 compares the correlation result 209 to the threshold 213 provided by the threshold module 212. The threshold module 212 may employ software, firmware, hardware or a combination thereof to provide the threshold 213, which is programmable. The threshold 213 may be constant during the cross-correlation process. Alternatively, the threshold 213 may vary during cross-correlation to test a correlation result over time thereby testing for certain levels of acceptability. Additionally, the threshold 213 may be adaptively selected based on an appropriate metric, such as a signal-to-noise ratio, of the received symbol. The comparison module 211 may integrate or otherwise smooth or filter the correlation result with respect to the threshold 213 or provide a comparison employing more than one received symbol. By thus employing an appropriate threshold, the packet detect signal 214 may enhance the quality of an OFDM packet reception.

Turning now to FIG. 3, illustrated is a flow diagram of an embodiment of a method of detecting an OFDM packet, generally designated 300, carried out in accordance with the principles of the present invention. The method 300 is employed with an OFDM receiver and starts in a step 305. A threshold, associated with an FFT placement peak, is determined in a step 310. The threshold employs a programmable threshold level, which may be determined in a manner that incorporates software, firmware or hardware, as well as any combination thereof. Additionally, the threshold may remain constant after selection or it may be altered as appropriate to a specific application. Then in a step 315, a received symbol is cross-correlated with a stored standard symbol to yield a correlation result.

In a decisional step 320, it is determined if the correlation result associated with the cross-correlation in the step 315 exceeds the threshold determined in the step 310. If the correlation result is not greater than the threshold, it is assumed that the received symbol is not part of a valid OFDM packet, and the method 300 returns to the step 310 wherein either the existing or another threshold may be employed with either the same or another received symbol. If the correlation result is greater than the threshold in the step 315, it is a verification that the received symbol is part of a valid OFDM packet, since the stored standard symbol is a long training sequence conforming to the IEEE 802.11a or the IEEE 802.11g standard. This action, therefore, indicates that the received symbol is a long training sequence, as desired. A packet detect signal is provided, in a step 325, indicating an FFT placement peak and a correct FFT placement location associated with the valid OFDM packet. The method 300 ends in a step 330.

While the method disclosed herein has been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps are not limitations of the present invention.

In summary, embodiments of the present invention employing an OFDM packet detect unit, a method of detecting and an OFDM receiver employing the unit or method have been presented. Advantages include providing better protection against accidentally triggering a packet detect condition due to noise or non-IEEE 802.11 a/g signals. Cross-correlating a long training sequence with an appropriate stored sequence provides an FFT placement peak. The FFT placement peak may then be compared against a threshold whose level is programmable and advantageously determined for a particular application. This combination of employing cross-correlation of a long training sequence with a programmable threshold provides an enhanced ability to establish the verification of an OFDM packet using the FFT placement peak.

Although the present invention has been described in detail, those skilled in the art should understand that they can make various changes, substitutions and alterations herein without departing from the spirit and scope of the invention in its broadest form.

1. An orthogonal frequency division multiplex (OFDM) packet detect unit, comprising:
a correlation indicator configured to cross-correlate a received symbol and a stored standard symbol to yield a correlation result; and
a threshold discriminator coupled to said correlation indicator and configured to produce a packet detect signal for a fast Fourier transform (FFT) placement peak based on a comparison between said correlation result and a threshold.

2. The packet detect unit as recited in claim 1 wherein said packet detect signal indicates a correct FFT placement location.

3. The packet detect unit as recited in claim 1 wherein said packet detect signal indicates a valid OFDM packet.

4. The packet detect unit as recited in claim 1 wherein said received symbol is a long training sequence.

5. The packet detect unit as recited in claim 1 wherein said stored standard symbol is a long training sequence conforming to a standard selected from the group consisting of:
IEEE 802.11a, and
IEEE 802.11g.

6. The packet detect unit as recited in claim 1 wherein said threshold is programmable.

7. The packet detect unit as recited in claim 6 wherein said threshold is embodied in one selected from the group consisting of:
software,
firmware, and
hardware.

8. A method of detecting an orthogonal frequency division multiplex (OFDM) packet, comprising:
cross-correlating a received symbol and a stored standard symbol to yield a correlation result; and
producing a packet detect signal for a fast Fourier transform placement (FFT) peak based on a comparison between said correlation result and a threshold.

9. The method as recited in claim 8 wherein said packet detect signal indicates a correct FFT placement location.

10. The method as recited in claim 8 wherein said packet detect signal indicates a valid OFDM packet.

11. The method as recited in claim 8 wherein said received symbol is a long training sequence.

12. The method as recited in claim 8 wherein said stored standard symbol is a long training sequence conforming to a standard selected from the group consisting of:
IEEE 802.11a, and
IEEE 802.11g.

13. The method as recited in claim 8 wherein said threshold is programmable.

14. The method as recited in claim 13 wherein said threshold is embodied in one selected from the group consisting of:
software,
firmware, and
hardware.

15. An orthogonal frequency division multiplex (OFDM) receiver, comprising:
a receive section that is coupled to a receive antenna;
a fast Fourier transform (FFT) section that is coupled to said receive section;
an OFDM packet detect unit coupled to said FFT section, including:
a correlation indicator that cross-correlates a received symbol and a stored standard symbol to yield a correlation result, and
a threshold discriminator, coupled to said correlation indicator, that produces a packet detect signal for a fast Fourier transform placement (FFT peak based on a comparison between said correlation result and a threshold; and
an output section that is coupled to said OFDM packet detect unit.

16. The receiver as recited in claim 15 wherein said packet detect signal indicates a correct FFT placement location.

17. The receiver as recited in claim 15 wherein said packet detect signal indicates a valid OFDM packet.

18. The receiver as recited in claim 15 wherein said received symbol is a long training sequence.

19. The receiver as recited in claim 15 wherein said stored standard symbol is a long training sequence conforming to a standard selected from the group consisting of:
IEEE 802.11a, and
IEEE 802.11g.

20. The receiver as recited in claim 15 wherein said threshold is programmable.

21. The receiver as recited in claim 20 wherein said threshold is embodied in one selected from the group consisting of:
software
firmware, and
hardware.
